(19) United States
(12) Patent Application Publication
(10) Pub. No.: US 2024/0127205 A1
(43) Pub. Date: Apr. 18, 2024

(54) TRANSFER OF DIGITAL CASH BETWEEN MOBILE COMMUNICATION DEVICE AND SMART CARD

(71) Applicant: CRUNCHFISH DIGITAL CASH AB, Malmö (SE)

(72) Inventors: Joachim Samuelsson, Helsingborg (SE); Paul Cronholm, Malmö (SE)

(21) Appl. No.: 18/274,604

(22) PCT Filed: Jan. 28, 2022
(86) PCT No.: PCT/SE2022/050090

§ 371 Date: Jul. 27, 2023

(30) Foreign Application Priority Data
Jan. 29, 2021 (SE) 2150109-3

(51) Int. Cl. G06Q 20/10; G06Q 20/20; G06Q 20/32; G06Q 20/36; G06Q 20/38; G06Q 20/40

(52) U.S. Cl. CPC G06Q 20/105; G06Q 20/20; G06Q 20/3229; G06Q 20/3278; G06Q 20/36; G06Q 20/38215; G06Q 20/3829; G06Q 20/40145; G06Q 2220/00

(57) ABSTRACT

A method of transferring digital cash comprises establishing (20) a local point-to-point communication link (CL) directly between a mobile communication device (MCD) and a smart card (SC) upon being in proximity of each other (10), then communicating (30) cash transfer data (CTD) over the local point-to-point communication link (CL). The cash transfer data (CTD) defines a local transfer of a monetary amount (Amount) from one of the mobile communication device (MCD) and the smart card (SC), being a cash sender, to the other of the mobile communication device (MCD) and the smart card (SC), being a cash receiver. The method further comprises updating (40) a balance (balance_ow) of a local digital wallet (OW) of the mobile communication device (MCD) as well as a balance (balance_card) of the cash deposit (CD) to reflect the local transfer of the monetary amount (Amount), such that the balance of the cash sender is reduced while the balance of the cash receiver is increased.

### TECHNICAL FIELD

The present invention generally relates to digital payments. More particularly, the present invention relates to technical improvements to facilitate transfer of digital cash and achieve a versatile ecosystem for digital payments. Even more particularly, the present invention relates to a digital cash transfer system, a mobile communication device, a smart card and a method of transferring digital cash.

### BACKGROUND

In this document, the terms “digital payment” and “digital cash” are, as such, to be construed broadly to embrace any kind of transfer of economic value in digital form between people and entities of any types, roles etc.

A typical situation is when a payer and a payee are physically proximate to each other, i.e. appear or meet at a physical place such as, for instance, a shop, restaurant, theatre, sport arena, workshop, or basically any place where humans can meet to perform a digital payment. As is well known, people can use different technical means to make digital payments, such as mobile communication devices and smart cards. Many smart cards are enabled for credit card payments at point of sales terminals, such as EMV (Europay, Mastercard and VISA) payments. Some smart cards take the form of a prepaid cash card having a local cash deposit that the possessor of the smart card can use at point of sales terminals to pay for goods or services, including tickets to public transportation, events, etc. There are also some dual functionality smart cards on the market, offering credit card payments as well as prepaid cash card payments.

The present inventors have realized that users of smart cards containing a local cash deposit (representing e.g. a prepaid amount) will benefit from being able to make convenient top-ups and/or top-downs of the balance of the local cash deposit on the smart card. The present inventors have conceived and developed novel and inventive manners of doing this, as will be explained in the remainder of this document.

### SUMMARY

In line with the observations above, the present inventors have made valuable technical insights. These insights will be presented as inventive aspects below as well as in the detailed description section, the claims and the drawings. The list of inventive aspects is not to be seen as exhaustive but rather a summary of particularly beneficial inventive aspects, as the skilled reader will understand.

A first inventive aspect is a digital cash transfer system that comprises a mobile communication device and a smart card. The mobile communication device has a local digital wallet and is configured for enabling a user of the mobile communication device to make digital payments from the local digital wallet by wide area network data communication and/or short-range wireless data communication. The smart card has secure electronic circuitry that accommodates a cash deposit and is configured for enabling a user of the smart card to make digital payments from the cash deposit at point of sales terminals. The mobile communication device and the smart card are configured to:

establish a local point-to-point communication link directly between the mobile communication device and the smart card upon being in proximity of each other;

communicate cash transfer data over the local point-to-point communication link, the cash transfer data defining a local transfer of a monetary amount from one of the mobile communication device and the smart card, being a cash sender, to the other of the mobile communication device and the smart card, being a cash receiver; and

update a balance of the local digital wallet as well as a balance of the cash deposit to reflect the local transfer of the monetary amount, such that the balance of the cash sender is reduced while the balance of the cash receiver is increased.

A second inventive aspect is a mobile communication device having at least one of an interface for wide area network data communication and an interface for short-range wireless data communication, and furthermore having an interface for local point-to-point communication. The mobile communication device moreover has a local digital wallet.

The mobile communication device is configured for enabling a user of the mobile communication device to make digital payments from the local digital wallet by at least one of wide area network data communication and short-range wireless data communication. The mobile communication device is further configured for participating in establishing of a local point-to-point communication link directly between the mobile communication device and a smart card when the mobile communication device and the smart card are in proximity of each other. The mobile communication device is moreover configured for participating in communication of cash transfer data over the local point-to-point communication link, the cash transfer data defining a local transfer of a monetary amount from one of the mobile communication device and the smart card, being a cash sender, to the other of the mobile communication device and the smart card, being a cash receiver. Finally, the mobile communication device is configured for updating a balance of the local digital wallet to reflect the local transfer of the monetary amount, such that the balance of the local digital wallet is reduced in case the mobile communication device is the cash sender and is increased in case the mobile communication device is the cash receiver.

In some embodiments, the local digital wallet may be accommodated in a trusted execution environment, TEE, or a secure element, SE. Other embodiments may however be possible for which sufficient data security and integrity is obtained by other measures.

The mobile communication device according to the second aspect of the invention may further have any or all of the characteristics as disclosed in this document for the mobile communication device in the digital cash transfer system according to the first aspect of the invention.

A third inventive aspect is a smart card having secure electronic circuitry accommodating a cash deposit, and an interface for local point-to-point communication. The smart card is configured for enabling a user of the smart card to make digital payments from the cash deposit at point of sales terminals. The smart card is further configured for:

participating in establishing of a local point-to-point communication link directly between the smart card and a mobile communication device when the smart card and the mobile communication device are in proximity of each other;

participating in communication of cash transfer data over the local point-to-point communication link, the cash transfer data defining a local transfer of a monetary amount from one of the smart card and the mobile communication device, being a cash sender, to the other of the smart card and the mobile communication device, being a cash receiver; and

updating a balance of the cash deposit to reflect the local transfer of the monetary amount, such that the balance of the cash deposit is reduced in case the smart card is the cash sender and is increased in case the smart card is the cash receiver.

The secure electronic circuitry constitutes a trusted execution environment, TEE, or a secure element, SE, for the cash deposit.

The smart card according to the third aspect of the invention may further have any or all of the characteristics as disclosed in this document for the smart card in the digital cash transfer system according to the first aspect of the invention.

The smart card may be embodied in different ways. In some embodiments, the smart card comprises a credit card-sized substrate carrying the secure electronic circuitry. In such embodiments, the interface for local point-to-point communication is typically also carried by the credit card-sized substrate, making the smart-card capable of autonomous operation as a stand-alone device.

In other embodiments, the smart card is a smart chip that contains the secure electronic circuitry but not necessarily the interface for local point-to-point communication. In such embodiments, the smart card may be accommodated in a small portable electronic device, such as a smart watch, a smart bracelet, a smart wearable, smart glasses or similar, which as such may provide the interface for local point-to-point communication.

In still other embodiments, the smart card is dimensioned as a subscriber identity module to fit in a subscriber identity module reader in a mobile phone, such as for instance a feature phone (i.e., not a smart phone) which is carried by the user of the smart card and which may provide the interface for local point-to-point communication if not provided within the smart card itself.

In yet other embodiments, the smart card may be a chip implant to be worn hypodermically by the user. In such embodiments, the secure electronic circuitry as well as the interface for local point-to-point communication may typically be contained within the smart card itself.

As is clear from the above, “a smart card having an interface for local point-to-point communication” shall be construed as a smart card (in the most general sense) that in operation has access to an interface for local point-to-point communication, rather than a smart card that in and by itself necessarily have to accommodate the interface for local point-to-point communication.

A fourth inventive aspect is a method of transferring digital cash, comprising:

establishing a local point-to-point communication link directly between a mobile communication device and a smart card upon being in proximity of each other;

communicating cash transfer data over the local point-to-point communication link, the cash transfer data defining a local transfer of a monetary amount from one of the mobile communication device and the smart card, being a cash sender, to the other of the mobile communication device and the smart card, being a cash receiver; and

updating a balance of a local digital wallet of the mobile communication device as well as a balance of the cash deposit to reflect the local transfer of the monetary amount, such that the balance of the cash sender is reduced while the balance of the cash receiver is increased.

Expressions like “[entity] is configured for . . . [performing activity]” or “[entity] is configured to . . . [perform activity]” will include typical cases where a computerized entity (having one or more controllers, processing units, programmable circuitry, etc.) executes software or firmware installed in the computerized entity, wherein the execution occurs in order to perform the activity in question.

Other aspects, objectives, features and advantages of the inventive aspects will appear from the following detailed disclosure as well as from the claims and the drawings. Generally, all terms used herein are to be interpreted according to their ordinary meaning in the technical field, unless explicitly defined otherwise herein.

All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

FIGS. 1 and 2 are schematic illustrations of a digital cash transfer system, mobile communication device, smart card and method of transferring digital cash in embodiments of the invention.

FIGS. 3A-3C represent sequence and signal diagrams illustrating certain activities for exchanging digital cash between a smart card and a mobile communication device having a mobile payment app in embodiments of the present invention.

FIGS. 4A-4C represent sequence and signal diagrams illustrating certain activities for transferring digital cash to a smart card from a point of sales terminal, for using a smart card to make an offline digital payment at a point of sales terminal, and for subsequently settling the digital payment at a payment service provider in embodiments of the present invention.

FIGS. 5A-5C represent sequence and signal diagrams which are alternatives to the sequence and signal diagrams in FIGS. 3A-3C, by adding functionality for handling risk limits.

FIGS. 6A-6C represent sequence and signal diagrams which are alternatives to the sequence and signal diagrams in FIGS. 4A-4C, by adding functionality for handling risk limits.

FIG. 7A is a schematic illustration of a computer-readable medium in one exemplary embodiment, capable of storing a computer program product.

FIG. 7B illustrates a multi-layered digital payment system architecture being an add-on to an existing payment service provider or core banking system.

### DETAILED DESCRIPTION

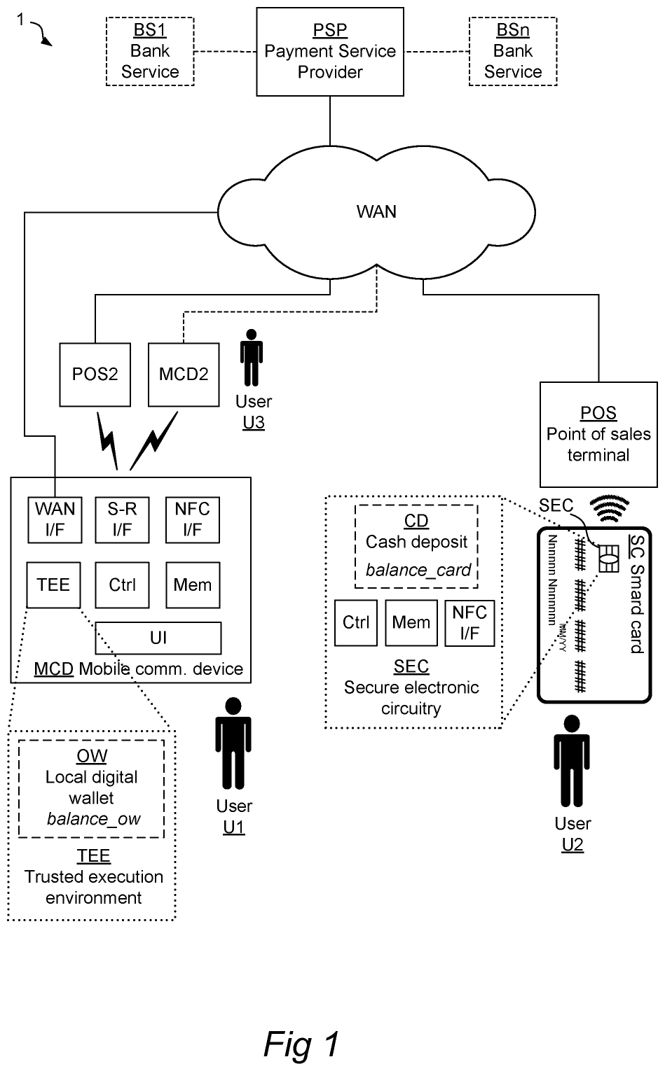

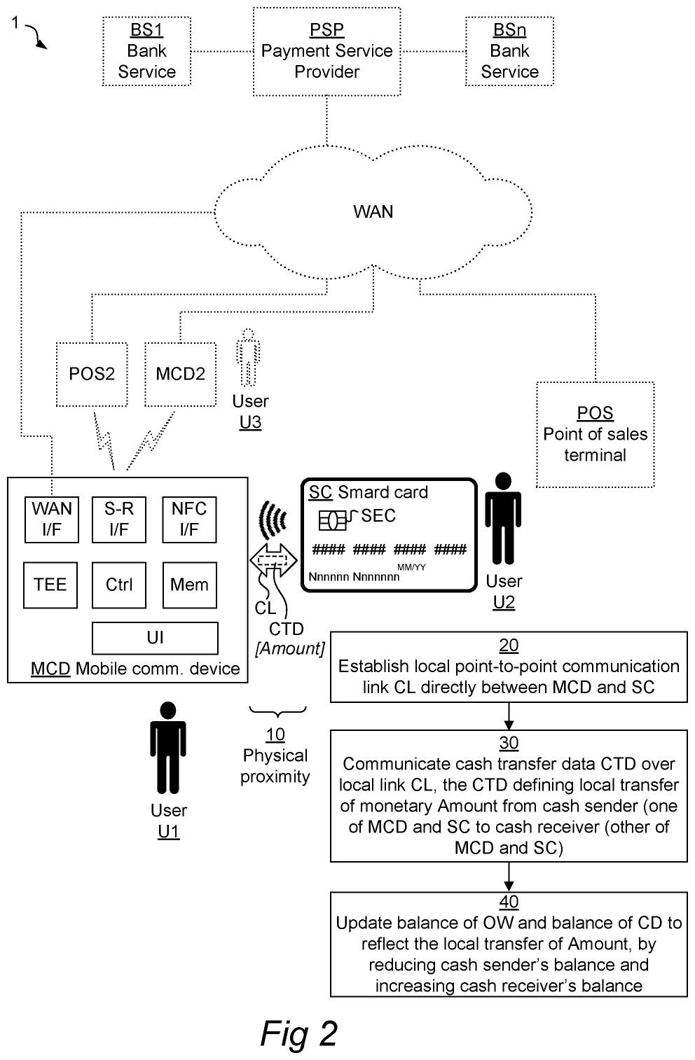

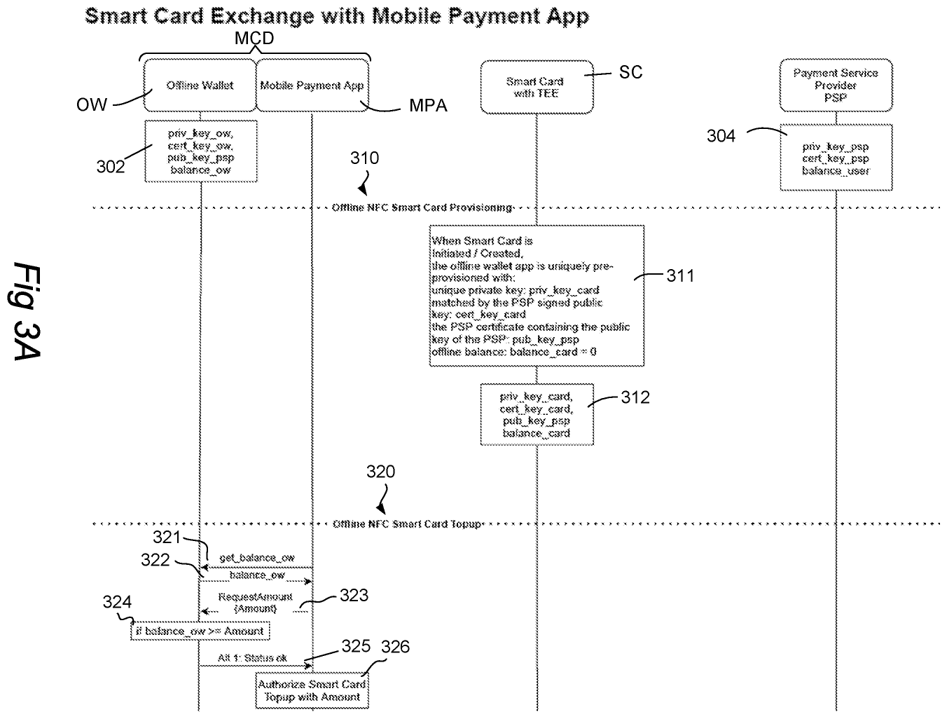

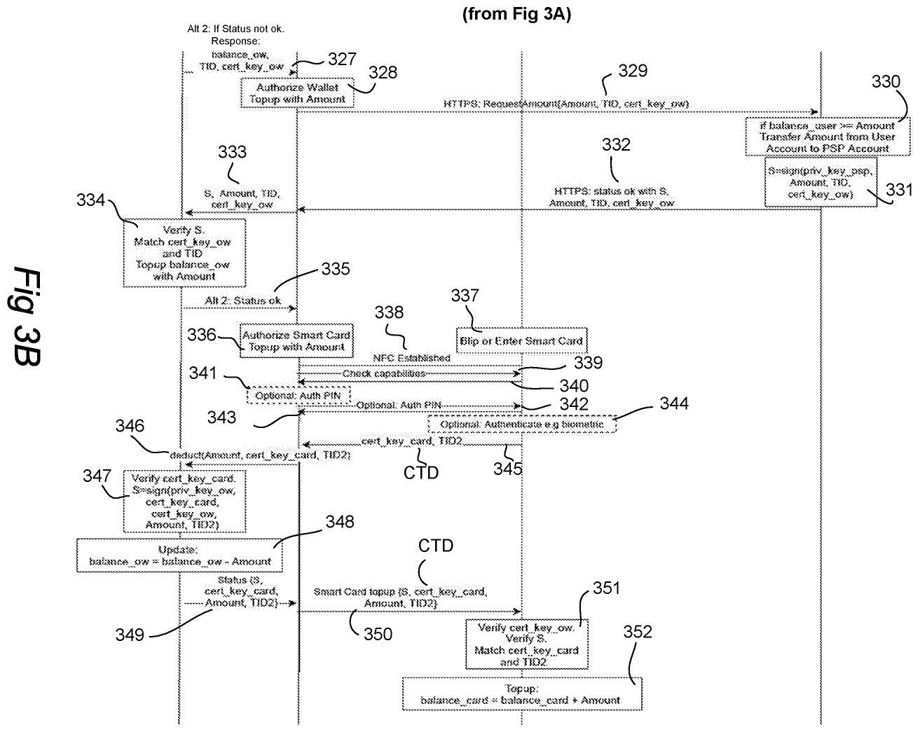

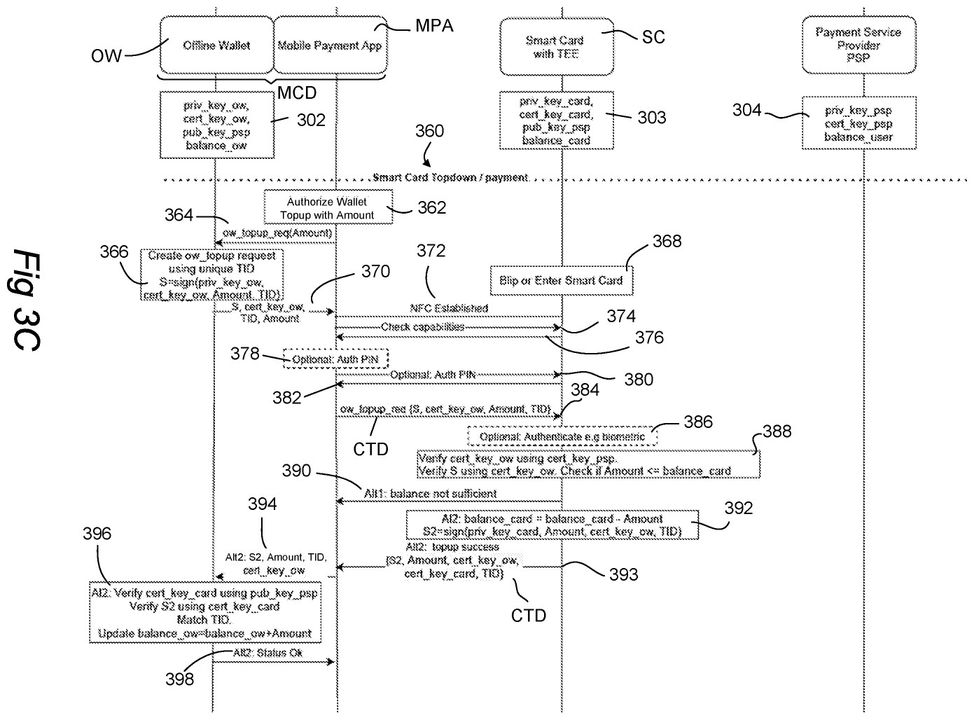

A digital cash transfer system 1 in embodiments of the invention can be seen in FIGS. 1 and 2. Further embodiments thereof, being refined but still exemplifying and non-limiting, are illustrated in FIGS. 3A-3C, 4A-4C, 5A-5C and 6A-6C.

### Digital Cash Transfer in General

The digital cash transfer system 1 comprises a mobile communication device MCD and a smart card SC. The mobile communication device MCD has a local digital wallet OW and is configured for enabling a user U1 of the mobile communication device MCD to make digital payments from the local digital wallet OW by wide area network data communication, short-range wireless data communication, or both.

The digital cash transfer system 1 moreover comprises a smart card SC which has secure electronic circuitry SEC that accommodates a cash deposit CD. The smart card SC is configured for enabling a user U2 of the smart card SC to make digital payments from the cash deposit CD at point of sales terminals (one example being seen at POS in FIGS. 1 and 2).

As can be seen in FIG. 2, the mobile communication device MCD and the smart card SC are configured to establish, in a step 20, a local point-to-point communication link CL directly between the mobile communication device MCD and the smart card SC upon being in proximity of each other, see 10. The local point-to-point communication link CL may, for instance, involve Near Field Communication, NFC.

The mobile communication device MCD and the smart card SC are further configured to communicate, in a step 30, cash transfer data CTD over the local point-to-point communication link CL. The cash transfer data CTD defines a local transfer of a monetary amount, Amount, from a cash sender in the form of one of the mobile communication device MCD and the smart card SC, to a cash receiver being the other of the mobile communication device MCD and the smart card SC. Hence, digital cash in the monetary amount Amount can be exchanged in either direction between the mobile communication device MCD and the smart card SC.

Moreover, the mobile communication device MCD and the smart card SC are configured to update, in a step 40, a balance balance_ow of the local digital wallet OW as well as a balance balance_card of the cash deposit CD to reflect the local transfer of the monetary amount Amount, such that the balance of the cash sender is reduced while the balance of the cash receiver is increased.

### The Mobile Communication Device

As can be seen in FIGS. 1 and 2, the illustrated embodiment of the mobile communication device MCD has at least one of an interface WAN I/F for wide area network data communication and an interface S-R I/F for short-range wireless data communication. It also has an interface NFC I/F for local point-to-point communication, and a local digital wallet OW.

Moreover, the mobile communication device MCD has a processing device Ctrl that serves as a controller of the mobile communication device MCD and that may be implemented in any known controller technology, including but not limited to microcontroller, processor (e.g. PLC, CPU, DSP), FPGA, ASIC or any other suitable digital and/or analog circuitry capable of performing the intended functionality. The mobile communication device MCD further has a memory Mem that may be implemented in any known memory technology, including but not limited to ROM, RAM, SRAM, DRAM, CMOS, FLASH, DDR, SDRAM, SSD or magnetic hard disk, or some other memory technology. In some embodiments, the memory or parts thereof may be integrated with or internal to the processing device Ctrl. The memory Mem may store program instruction for execution by the processing device Ctrl, as well as temporary and permanent data for use by the processing device Ctrl.

The mobile communication device MCD has a user interface UI, as is commonplace in the art. The user interface UI comprise an input device and a presentation device. The input device and the presentation device may be constituted by one common physical device, such as for instance a touch screen (touch-sensitive display screen), implemented in for instance resistive touch technology, surface capacitive technology, projected capacitive technology, surface acoustic wave technology or infrared technology.

As has been explained above, the mobile communication device MCD is configured for enabling a user U1 of the mobile communication device MCD to make digital payments from the local digital wallet OW by at least one of wide area network data communication (cf. interface WAN I/F) and short-range wireless data communication (cf. interface S-R I/F).

Seen from the perspective of the mobile communication device MCD in FIG. 2, the mobile communication device MCD is further configured for participating in the establishing (cf. step 20) of a local point-to-point communication link CL directly between the mobile communication device MCD and a smart card SC when the mobile communication device MCD and the smart card SC are in proximity of each other (cf. 10 in FIG. 2). The mobile communication device MCD is moreover configured for participating in the communication (cf. step 30) of cash transfer data CTD over the local point-to-point communication link CL, wherein the cash transfer data CTD defines a local transfer of a monetary amount Amount from one of the mobile communication device MCD and the smart card SC, being a cash sender, to the other of the mobile communication device MCD and the smart card SC, being a cash receiver. Also, the mobile communication device MCD is configured for updating (cf. step 40) a balance balance_ow of the local digital wallet OW to reflect the local transfer of the monetary amount Amount, such that the balance balance_ow of the local digital wallet OW is reduced in case the mobile communication device MCD is the cash sender and is increased in case the mobile communication device MCD is the cash receiver.

### The Smart Card

As can further be seen in FIGS. 1 and 2, the illustrated embodiment of the smart card SC has secure electronic circuitry SEC accommodating a cash deposit CD (i.e., a cash depository). The secure electronic circuitry SEC constitutes a trusted execution environment, TEE, or a secure element, SE, for the cash deposit CD.

The smart card SC further has an interface NFC I/F for local point-to-point communication. As explained in the Summary section, the interface NFC I/F may be an integral part of the smart card SC in some embodiments, but in other embodiments it may be an external resource that the smart card SC has access to.

Hence, the smart card SC can be embodied in various different ways. In some embodiments, the smart card SC comprises a credit card-sized substrate carrying the secure electronic circuitry SEC. In some embodiments, the smart card SC is a smart chip that comprises (accommodates) the secure electronic circuitry SEC, but not necessarily the interface NFC I/F; it suffices that the smart card SC with its secure electronic circuitry SEC has access to the interface NFC I/F. Such access may be obtained in some embodiments where the smart chip is dimensioned as a subscriber identity module to fit in a subscriber identity module reader in a second mobile communication device carried by the user U2 of the smart card SC. In other embodiments, the smart card may be accommodated as a smart chip in a small portable electronic device, such as a smart watch, a smart bracelet, a smart wearable, smart glasses or similar, which as such provides the interface for local point-to-point communication.

In some embodiments, the smart card SC is compatible with EMV (Europay, Mastercard and VISA) payments.

As has been explained above, the smart card SC is configured for enabling the user U2 of the smart card SC to make offline digital payments from the cash deposit CD at point of sales terminals (cf. POS in FIGS. 1 and 2).

Seen from the perspective of the mobile communication device MCD in FIG. 2, the smart card SC is further configured for participating in the establishing (cf. step 20) of a local point-to-point communication link (CL) directly between the smart card SC and a mobile communication device MCD when the smart card 20 and the mobile communication device MCD are in proximity of each other (cf. 10 in FIG. 2). Moreover, the smart card SC is configured for participating in communication (cf. step 30) of cash transfer data CTD over the local point-to-point communication link CL, wherein the cash transfer data CTD defines a local transfer of a monetary amount Amount from one of the smart card 20 and the mobile communication device MCD, being a cash sender, to the other of the smart card 20 and the mobile communication device MCD, being a cash receiver. Also, the smart card SC is configured for updating 40 a balance balance_card of the cash deposit CD to reflect the local transfer of the monetary amount Amount, such that the balance balance_card of the cash deposit CD is reduced in case the smart card SC is the cash sender and is increased in case the smart card SC is the cash receiver.

As can be seen in FIGS. 1 and 2, in addition to the mobile communication device MCD and the smart card SC, the disclosed embodiment of the digital cash transfer system 1 further comprises a computerized payment service provider PSP and a point of sales terminal POS. As can be seen, it may further comprise a second point of sales terminal POS2 and a second mobile communication device MCD2.

As can be understood from FIG. 1, the user U1 of the mobile communication device MCD may make online digital payments from the local digital wallet OW by wide area network data communication (via WAN I/F and a wide area network WAN) directly with the computerized payment service provider PSP to make online payments. Alternatively or additionally, the user U1 of the mobile communication device MCD may make offline digital payments from the local digital wallet OW by short-range wireless data communication (via S-R I/F) with the second mobile communication device MCD2 or the second point of sales terminal POS2. Some non-limiting examples of suitable technology for such purposes are described in the present inventors' PCT application PCT/SE2020/051251 as well as in the present inventors' Swedish patent application bearing the title “COMPUTERIZED METHOD AND SYSTEM FOR DIGITAL PAYMENTS” which is filed concurrently with the present application and claims priority from Swedish patent applications 2151468-2 and 2151529-1. The contents of these applications are incorporated herein by reference. Likewise, the user U2 of the smart card SC may make digital payments from the cash deposit CD by local point-to-point communication with the point of sales terminal POS (or, analogously, with the second point of sales terminal POS2 via interface NFC I/F).

### The Payment Cycle

Hence, in this embodiment, the digital cash transfer system 1 comprises at least the following entities: the mobile communication device MCD, the smart card SC, the computerized payment service provider PSP and the point of sales terminal POS. There may be other central resources involved as well for the purpose of settlement (including clearing), such as a computerized payment switch, a computerized central bank system and computerized bank services (the latter being seen as BS1 . . . BSn in FIGS. 1 and 2.

The digital cash transfer system 1 is capable of the activities:

A) The payment service provider PSP is configured to communicate with the mobile communication device MCD by wide area network data communication to increase the balance of the local digital wallet OW in the mobile communication device MCD by transferring funds from an account associated with the user U1 of the mobile communication device MCD to an account associated with the payment service provider PSP.

B) The point of sales terminal POS is configured for local point-to-point communication with the smart card SC to receive a digital payment made at the point of sales terminal POS by the user U2 of the smart card SC from the cash deposit CD therein, and is configured to transmit said digital payment to the payment service provider PSP by wide area network data communication.

C) The payment service provider PSP is further configured to receive said digital payment made at the point of sales terminal POS by the user U2 of the smart card SC, and to cause settlement by causing transfer of funds from an account associated with the payment service provider PSP to an account associated with the point of sales terminal POS.

The activity at A) above will allow the user U1 to top up the local digital wallet OW in the mobile communication device MCD with funds from an account associated with the user U1. The payment service provider PSP assumes responsibility for future settlement of digital payments made from the increased balance of the local digital wallet OW by acting as a payment pool; such future settlements may be made against the account associated with the payment service provider PSP. This is so even if the funds are transferred from the local digital wallet OW in the mobile communication device MCD to the cash deposit CD in the smart card SC pursuant to the present invention. See steps 10-40 as described for FIG. 2. The payment service provider PSP will hence still assume responsibility for the settlement at C) above for payments that are subsequently made at B) by the user U2 with thus increased funds from the cash deposit CD in the smart card SC.

Implementation examples of activity A) above can be seen at steps 327-334 at stage 320 in FIGS. 3A-3B.

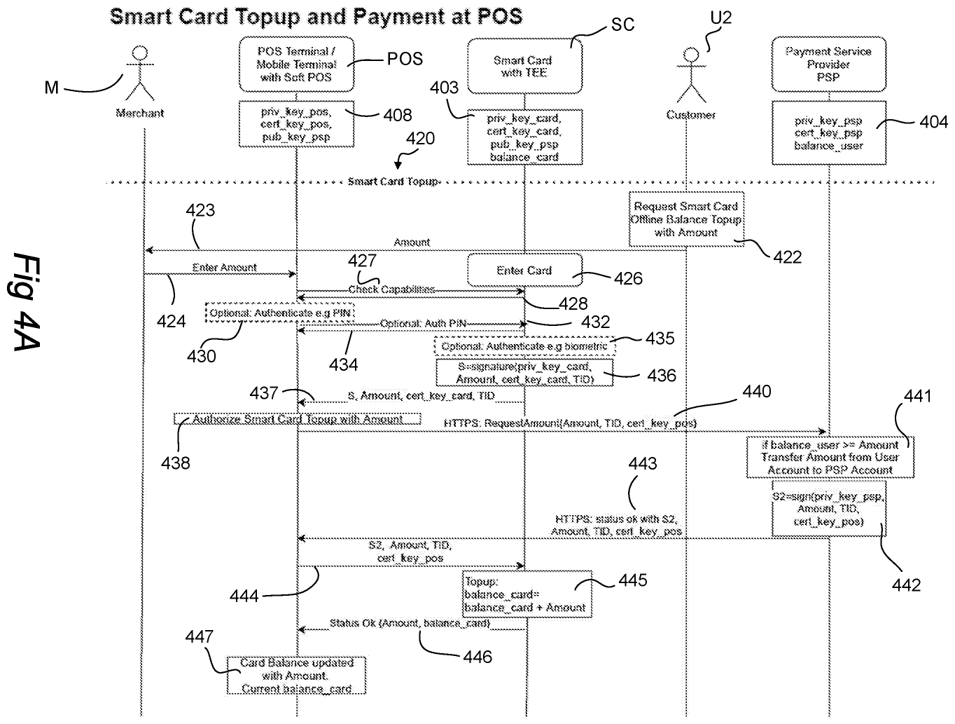

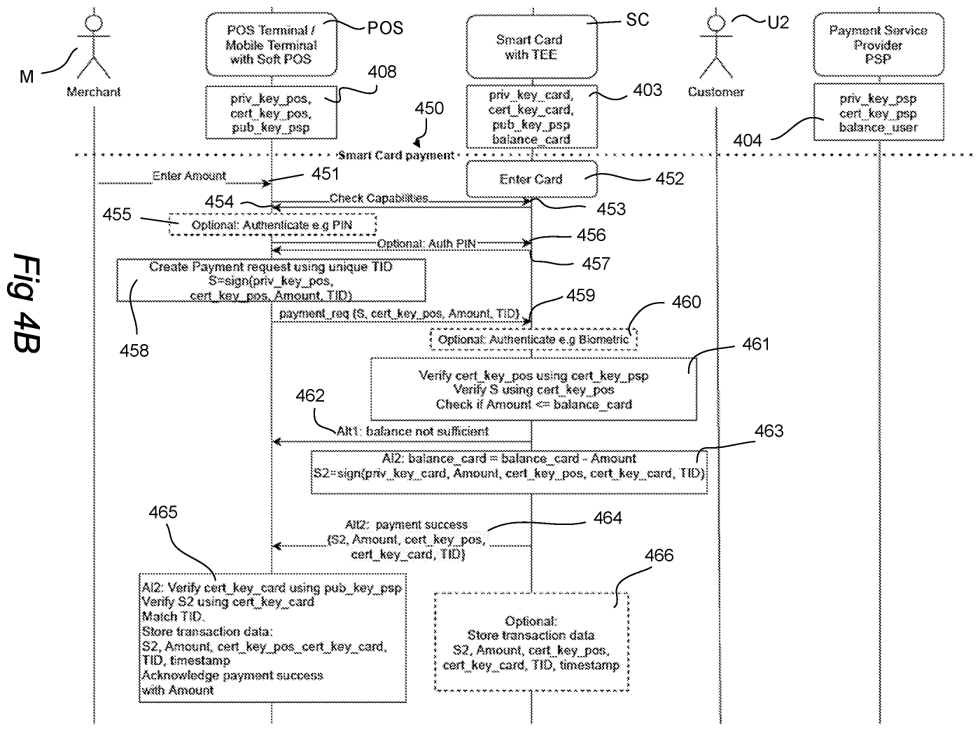

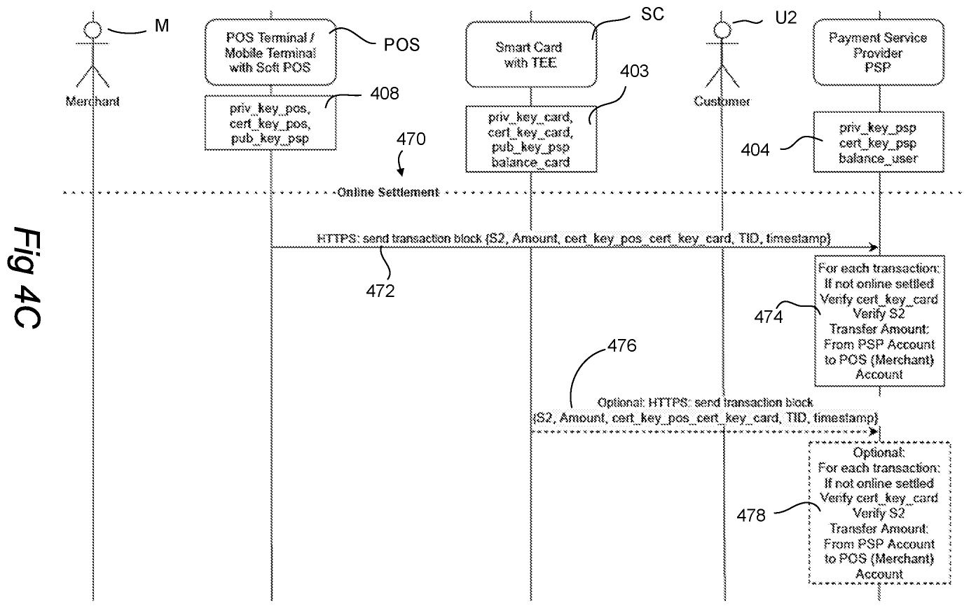

Implementation examples of activities B) and C) above can be seen at stages 450 and 470 in FIGS. 4B-4C.

The user U1 and payment service provider PSP accounts may be administered by the payment service provider PSP itself or by separate financial institute(s) (cf. computerized bank services BS1 . . . BSn in FIGS. 1 and 2).

As will be understood from the description above, a novel and inventive way of transferring digital cash between the users U1 and U2 is illustrated in FIG. 2. The transfer of digital cash takes place by moving the mobile communication device MCD and the smart card SC in proximity (cf. 10) of each other, and establishing (step 20) a local point-to-point communication link CL directly between the mobile communication device MCD and the smart card SC when they are proximate to each other. The typical approach will be for the user U2 to tap the smart card SC onto the mobile communication device MCD in much the same way as a smart card is “blipped” at a point of sales terminal (e.g. card reader). However, the opposite manner may also be employed (i.e., with the smart card SC being kept still while bringing the mobile communication device MCD immediately close).

When the local point-to-point communication link CL has been established, cash transfer data CTD will be communicated (step 30) over the link CL. The cash transfer data CTD defines a local transfer of a monetary amount Amount from one of the mobile communication device MCD and the smart card SC, being a cash sender, to the other of the mobile communication device MCD and the smart card SC, being a cash receiver.

In response, a balance balance_ow of the local digital wallet OW as well as a balance balance_card of the cash deposit CD are updated (step 40) to reflect the local transfer of the monetary amount Amount, such that the balance of the cash sender is reduced while the balance of the cash receiver is increased. Implementation examples for steps 20-40 in FIG. 2 can be seen at the stages “Offline NFC Smart Card Topup” 320 and “Smart Card Topdown/Payment” 360 in FIGS. 3A-3C.

### Smart Card Topup from Mobile Communication Device

Accordingly, when the mobile communication device MCD is the cash sender and the smart card SC is the cash receiver, the balance balance_ow of the local digital wallet OW is reduced by the transferred monetary amount Amount, whereas the balance balance_card of the cash deposit CD is increased by the transferred monetary amount Amount. This enables the user U2 of the smart card SC to make digital payments in a higher total amount than prior to receiving the transferred monetary amount Amount. For an implementation example, see stage 320 in FIGS. 3A and 3B.

### Online Topup of Local Digital Wallet if Needed

Advantageously, the mobile communication device MCD is configured to make an online topup or refill of its local digital wallet OW when needed for the transfer of digital cash to the smart card SC. This will involve the mobile communication device MCD determining that the balance balance_ow of the local digital wallet OW is less than the monetary amount Amount to be transferred to the smart card SC. When the insufficiency has been determined, the mobile communication device MCD will communicate with the payment service provider PSP by wide area network data communication to increase the balance balance_ow of the local digital wallet OW in the mobile communication device MCD by transferring funds from an account associated with the user U1 of the mobile communication device MCD to an account associated with the payment service provider PSP. For an implementation example, see steps 324 and 327-335 in stage 320 in FIGS. 3A and 3B.

### Smart Card Payment (“Topdown”) to Mobile Communication Device

When, on the other hand, the smart card SC is the cash sender and the mobile communication device MCD is the cash receiver, the balance balance_ow of the local digital wallet OW is increased by the transferred monetary amount Amount whereas the balance balance_card of the cash deposit CD is reduced by the transferred monetary amount Amount. In this case, the transferred monetary amount Amount serves as a local digital payment (offline digital payment) being made by the user U2 of the smart card SC, acting as a payer, directly to the user U1 of the mobile communication device MCD, acting as a payee, over the local point-to-point communication link CL. For an implementation example, see stage 360 in FIGS. 3A and 3B.

### Further Payment to Other Mobile Communication Device

Advantageously, the mobile communication device MCD may use the payment/topdown received from the smart card SC to make a payment to another mobile communication device. In other words, the balance balance_ow of the local digital wallet OW as increased by the transferred monetary amount Amount is available for the user U1 of the mobile communication device MCD, acting as a payer, to make a subsequent digital payment to a user U3 of another mobile communication device MCD2, acting as a payee. The subsequent digital payment may be in an amount that corresponds to the full or partial increase of the balance balance_ow of the local digital wallet OW in the mobile communication device MCD. Hence, the received digital cash (i.e. the local digital payment/offline digital payment) that has been transferred from the cash deposit CD in the smart card SC over the local point-to-point communication link CL to the mobile communication device MCD will be available for the user U2 at will. The user U2 may accordingly use that digital cash for further digital payments, for instance to the user U3 of the second mobile communication device MCD2.

### Smart Card Topup at Point of Sales Terminal

The description above referred to a case where the user U2 made a topup of the smart card SC from the mobile communication device MCD. As an alternative, the topup of the smart card SC may be made at the point of sales terminal POS. To this end, the payment service provider PSP will be further configured for wide area network data communication with the point of sales terminal POS. Moreover, the point of sales terminal POS will be further configured for local point-to-point communication with the smart card SC, so as to increase the balance balance_card of the cash deposit CD in the smart card SC by transferring funds from an account associated with the user U2 of the smart card SC to an account associated with the payment service provider PSP. For an implementation example, see stage 420 in FIGS. 4A and 4B.

### Trust Built by Digital Signature Technology

Trust can be added to the digital cash transfer system 1 by the following provisions. In some embodiments, the mobile communication device MCD has a certificate cert_key_ow which comprises a public cryptographic key, signed by the payment service provider PSP. The mobile communication device MCD further has a private cryptographic key priv_key_ow, associated with its public cryptographic key and stored in local memory. This can be seen at 302 in FIG. 3A.

The smart card SC has a certificate cert_key_card which comprises a public cryptographic key, signed by the payment service provider PSP. The smart card SC further has a private cryptographic key priv_key_card, associated with its public cryptographic key and stored in local memory. This can be at 312 in FIG. 3A and 303 in FIG. 3C.

The payment service provider PSP has a certificate cert_key_psp which comprises a public cryptographic key pub_key_psp that allows verification of the certificates cert_key_ow and cert_key_card of the mobile communication device MCD and the smart card SC, and which is made available to the mobile communication device MCD and the smart card SC. This can be seen at 302, 304 and 312 in FIG. 3A.

The mobile communication device MCD and the smart card SC are configured, in connection with the communication of cash transfer data CTD over the local point-to-point communication link CL, to exchange their certificates cert_key_ow and cert_key_card, thereby allowing mutual verification thereof using the certificate cert_key_psp (public key pub_key_psp) of the payment service provider PSP. The cash sender is configured to sign the cash transfer data CTD or parts thereof using its private cryptographic key priv_key_ow or priv_key_card, whereas the cash receiver is configured to verify the signed cash transfer data CTD or signed parts thereof using the certificate of the cash sender cert_key_card or cert_key_ow as verified by the certificate cert_key_psp of the payment service provider PSP. Successful verification will be a requisite for updating the balance of the cash receiver. This can be seen at stages 320 and 360 in FIGS. 3A-3C and at stages 420 and 450 in FIGS. 4A-4C.

### Additional Trust and Security by Biometric Verification in Smart Card

In some embodiments, the secure electronic circuitry SEC in the smart card SC accommodates biometric reference data pertaining to one or more biometric features of the user U2 of the smart card SC. In such embodiments, the smart card SC is configured to read a biometric sample from the user U2 of the smart card (SC), and perform a biometric authentication of the biometric sample. The biometric authentication is concluded as successful when the biometric sample matches the biometric reference data. Advantageously, successful biometric authentication of the user U2 of the smart card SC is a requisite for the smart card SC to participate in the local transfer of the monetary amount Amount. Implementation examples can be seen in FIGS. 3A-3C as well as FIGS. 4A-4C. The biometric sample may, for instance, be a fingerprint, a palm vein scan, a face scan, a DNA sample, a palm print, a hand geometry scan, an iris scan or a retina scan, without limitation.

### Method of Transferring Digital Cash

As will be clear from the description above with particular reference to FIGS. 1 and 2, one aspect of the invention can be seen as a method of transferring digital cash, comprising the following steps:
Establishing (step 20 in FIG. 2) a local point-to-point communication link CL directly between a mobile communication device MCD and a smart card SC upon being in proximity of each other (see 10 in FIG. 2).
Communicating (step 30 in FIG. 2) cash transfer data CTD over the local point-to-point communication link CL, the cash transfer data CTD defining a local transfer of a monetary amount Amount from one of the mobile communication device MCD and the smart card SC, being a cash sender, to the other of the mobile communication device MCD and the smart card SC, being a cash receiver.
Updating (step 40 in FIG. 2) a balance balance_ow of a local digital wallet OW of the mobile communication device MCD as well as a balance balance_card of the cash deposit CD to reflect the local transfer of the monetary amount Amount, such that the balance of the cash sender is reduced while the balance of the cash receiver is increased.

Advantageously, the method may further comprise:
A computerized payment service provider PSP communicating with the mobile communication device MCD by wide area network data communication to increase the balance of the local digital wallet OW in the mobile communication device MCD by transferring funds from an account associated with a user U1 of the mobile communication device MCD to an account associated with the payment service provider PSP.
A point of sales terminal POS performing local point-to-point communication with the smart card SC to receive a digital payment made at the point of sales terminal POS by a user U2 of the smart card SC from the cash deposit CD.
The point of sales terminal POS transmitting the digital payment to the payment service provider PSP by wide area network data communication.
The payment service provider PSP receiving the digital payment made at the point of sales terminal POS by the user U2 of the smart card SC.
The payment service provider PSP causing settlement by causing transfer of funds from an account associated with the payment service provider PSP to an account associated with the point of sales terminal POS.

### Implementation Examples

Some implementation examples will now be presented with reference to the flowchart diagrams in FIGS. 3A-6C.

FIGS. 3A-3C illustrate certain activities for exchanging digital cash between the smart card SC and the mobile communication device MCD in example embodiments of the present invention. Three entities are shown in this drawing: the mobile communication device MCD, the smart card SC and the payment service provider PSP. In addition to the local digital wallet OW, the mobile communication device MCD has a mobile payment app MPA, i.e. an application program defined by computer program code stored in the memory Mem and being executable by the processing device Ctrl of the mobile communication device MCD.

As can be seen at 302, the balance of the local digital wallet OW is represented by the aforementioned balance_ow. The aforementioned cryptographic data priv_key_ow, cert_key_ow and pub_key_psp (part of cert_key_psp) are stored in the local digital wallet OW (or in the secure environment TEE which accommodates the local digital wallet OW, at least as regards priv_key_ow).

Correspondingly, the payment service provider PSP has access to the aforementioned cryptographic data cert_key_psp and a corresponding private cryptographic key priv_key_psp. The payment service provider PSP also maintains a balance_user variable, being a balance of an account associated with the user U1 of the mobile communication device MCD. This can be seen at 304.

In a first stage in FIG. 3A, the smart card SC is provisioned. This can be seen in steps 311 and 312. The balance balance_card of the cash deposit CD of the smart card SC is initially set to 0, and the aforementioned cryptographic data priv_key_card, cert_key_card and pub_key_psp (part of cert_key_psp) are stored in the trusted execution environment (or secure element) constituted by the secure electronic circuitry SEC on the smart card SC.

Stage 320 illustrates a topup of the smart card SC from the mobile communication device MCD. The topup is typically requested in a certain amount Amount by the user U1 in the mobile payment app MPA, or automatically by the app, see steps 321-323. The digital wallet OW checks that its balance_ow is enough to cover the requested transfer in step 324. If so, the user U1 may be asked to authorize the smart card topup in the user interface UI of the mobile communication device MCD in step 326. After authorization, the next activity will be steps 337 and 338 in FIG. 3B.

If on the other hand the balance_card is found to be insufficient in step 325, the mobile communication device MCD may make an online topup or refill of the local digital wallet OW by communicating with the payment service provider PSP to increase balance_ow by transferring funds from the account associated with the user U1 (i.e., the one having the aforementioned balance balance_user) to an account associated with the payment service provider PSP. This is shown in steps 327-335 in FIG. 3B. In effect, the topup of balance_ow in the MCD by the requested amount Amount is covered in a controlled manner by allowing the PSP to withdraw funds in a corresponding amount from the user's U1 account at the PSP in step 330. The topup activity furthermore involves communication 329 of a transaction identifier TID and the cert_key_ow to the PSP, signing 331 by the PSP of a topup record that includes Amount, TID and cert_key_ow using priv_key_psp, and communicating 332, 333 the signed topup record to the MCD and its digital wallet OW. Upon receipt, the OW will verify in step 334 the signed topup record using pub_key_psp, and check that TID and cert_key_ow are the same as the ones sent in step 329, and confirm to the app MPA in step 335 which may request an authorization by the user U1 in step 336.

This brings us to steps 337 and 338 where the actual topup of the smart card SC begins by the user U1 blipping 337 or otherwise presenting the smart card SC to the mobile communication device MCD. The local point-to-point communication link CL is established in step 338 (cf. step 20 in FIG. 2) and is followed by certain capability checks and authentication steps 339-344 in FIG. 3B. The smart card SC sends a topup initiation message 345 to the app MPA in the MCD, and the MPA makes a deduction request 346 to its digital wallet OW. The deduction request 346 includes a transaction identifier TID2, the cert_key_card and the requested Amount.

In step 347, the digital wallet OW verifies cert_key_card using the certificate cert_key_psp of the payment service provider PSP. It then generates a smart card topup record that includes Amount, TID2, cert_key_card and cert_key_ow, and signs the smart card topup record using priv_key_ow. In step 348, the digital wallet OW completes its part of the topup by reducing balance_ow by Amount, and updates the MPA in step 349. In response, the MPA sends a smart card topup instruction 350 to the smart card SC. The smart card topup instruction 350 contains the generated smart card topup record (cf. cash transfer data CTD in FIGS. 1 and 2) and thus includes Amount, TID2 and cert_key_ow, and also the signature S made by the digital wallet OW in step 347.

In step 351, the smart card SC verifies cert_key_ow using the certificate cert_key_psp of the payment service provider PSP, and then verifies the signature S using the verified cert_key_ow. The smart card SC further checks that TID2 and cert_key_card are the same as the ones sent in step 345. Upon success, the smart card SC completes the topup by increasing balance_card by Amount.

FIG. 3C illustrates in stage 360 a transfer of digital cash in the other direction, i.e. in the form of a topdown or offline digital payment from the smart card SC to the mobile communication device MCD. The user U1 of the mobile communication device MCD authorizes a topup of the digital wallet OW in a requested Amount in step 362 in the app MPA, which calls upon the digital wallet OW in step 364. In response, the digital wallet OW generates a digital wallet topup record in step 366, the record including cert_key_ow, Amount and a transaction identifier TID. The digital wallet topup record is signed using priv_key_ow and is sent to the app MPA in step 370.

The local point-to-point communication link CL is established in step 372 (cf. step 20 in FIG. 2) and is followed by certain capability checks and authentication steps 374-382 and 386 in FIG. 3C. The app MPA in the MCD sends a digital wallet topup request 384 to the smart card SC. The request 384 contains the generated digital wallet topup record from step 366 (cf. cash transfer data CTD in FIGS. 1 and 2) and thus includes Amount, TID and cert_key_ow, and also the signature S made by the digital wallet OW in step 366.

In step 388, the smart card SC verifies cert_key_ow using the certificate cert_key_psp of the payment service provider PSP, and then verifies the signature S using the verified cert_key_ow. The smart card SC further checks that balance_card covers the requested Amount. If balance_card is insufficient, the requested transfer of digital cash cannot be made, as seen in step 390.

If step 388 is successful, the smart card SC completes the topup in step 392 by reducing balance_card by Amount. The smart card SC also generates a digital wallet topup response 393 that contains the cash transfer data from the digital wallet topup request 384, i.e. Amount, TID and cert_key_ow, and in addition also cert_key_card, and signs it using priv_key_card, resulting in signature S2. The signed digital wallet topup response 393 is sent to the app MPA that forwards the data to the digital wallet OW in step 394.

In step 396, the digital wallet OW verifies cert_key_card using the certificate cert_key_psp of the payment service provider PSP, and then verifies the signature S2 using the verified cert_key_card. The digital wallet OW further checks that TID is the right one. Upon success, the digital wallet OW completes the topup by increasing balance_ow by Amount, and provides a completion status at 398 to the app MPA.

FIGS. 4A-4C illustrate certain activities for transferring digital cash to the smart card SC from the point of sales terminal POS (FIG. 4A), for using the smart card SC to make an offline digital payment at the point of sales terminal POS (FIG. 4B), and for subsequently settling the offline digital payment online at the payment service provider PSP (FIG. 4C) in example embodiments of the present invention. The point of sales terminal POS may be operated by a merchant M.

The smart card SC keeps the same cryptographic data and balance_card as in FIGS. 3A-3C, see 403. Similarly, the payment service provider PSP keeps the same cryptographic data and balance_user as in FIGS. 3A-3C, see 404. As seen at 408, the point of sales terminal POS has a digital certificate cert_key_pos which comprises a public cryptographic key, signed by the payment service provider PSP. The point of sales terminal POS further has a private cryptographic key priv_key_pos, associated with its public cryptographic key and stored in local memory. Finally, the point of sales terminal POS has access to pub_key_psp which is a part of the PSP's digital certificate cert_key_psp.

Stage 420 in FIG. 4A illustrates a topup of the smart card SC from the point of sales terminal POS. The topup is typically requested in a certain amount Amount by the user U2 by providing (e.g. blipping, tapping, inserting) the smart card at the point of sales terminal POS, see steps 422-426. The local point-to-point communication link CL is established by, for instance, NFC or a serial galvanic interface (cf. step 20 in FIG. 2) and is followed by certain capability checks and authentication steps 427-435 in FIG. 4A. The smart card SC generates a smartcard topup record in step 436 (cf. CTD in FIG. 2). The record includes cert_key_card, Amount and a transaction identifier TID. The smartcard topup record is signed using priv_key_card and is sent to the point of sales terminal POS in step 437. At 438, the point of sales terminal POS verifies the signature S of the smart card SC using cert_key_card and optionally asks the user U2 to authorize the topup Amount.

The point of sales terminal POS then sends a settlement request to the payment service provider PSP in step 440, the settlement request including the data from the smartcard topup record. In step 441, the payment service provider PSP verifies that balance_user covers the requested Amount. If so, the requested topup of the smart card SC is financed by transferring funds from the account associated with the user U2 (i.e., the one having the aforementioned balance balance_user) to an account associated with the payment service provider PSP. As proof, the payment service provider PSP signs the data of the smartcard topup record using priv_key_psp in step 442 and sends it to the point of sales terminal POS in step 443. The data is relayed at 444 to the smart card SC. Either the point of sales terminal POS or the smart card SC may verify the signature S2 made by the PSP in step 442, using cert_key_psp.

Upon successful verification, the smart card SC completes the topup by adding Amount to balance_card in step 445. The point of sales terminal POS is notified accordingly by a status message in step 446, and the user U2 may ultimately be given a visual confirmation of the topup by the point of sales terminal POS in step 447.

Turning now to FIG. 4B, stage 450 illustrates how the user U2 may use the smart card SC to make an offline digital payment in a requested amount Amount at the point of sales terminal POS (merchant M). The offline digital payment is typically requested in a certain amount Amount by the user U2 or merchant M by providing (e.g. blipping, tapping, inserting) the smart card SC at the point of sales terminal POS. Accordingly, the local point-to-point communication link CL is established by, for instance, NFC or a serial galvanic interface (cf. step 20 in FIG. 2) in conjunction with certain capability checks and authentication steps, see steps 452-457.

The point of sales terminal POS generates a smartcard payment record in step 458 (cf. CTD in FIG. 2). The record includes cert_key_pos, Amount and a transaction identifier TID. The smartcard payment record is signed using priv_key_pos and is sent in an offline digital payment request 459 to the smart card SC. Optional authentication, e.g. biometric, may occur at a step 460.

At 461, the smart card SC verifies cert_key_pos using the certificate cert_key_psp of the payment service provider PSP, and then verifies the signature S made by the POS using the verified cert_key_pos. The smart card SC further checks that balance_card covers the requested Amount. If balance_card is insufficient, the requested offline digital payment cannot be made, as seen in step 462.

If step 461 is successful, the smart card SC completes its part of the offline digital payment in step 463 by reducing balance_card by Amount. The smart card SC also generates an offline digital payment response 464 that contains the cash transfer data from the offline digital payment request 459, i.e. Amount, TID and cert_key_pos, and in addition also cert_key_card, and signs it using priv_key_card, resulting in signature S2. The signed offline digital payment response 464 is sent to the point of sales terminal POS.

In step 465, the point of sales terminal POS verifies cert_key_card using the certificate cert_key_psp of the payment service provider PSP, and then verifies the signature S2 using the verified cert_key_card. The point of sales terminal POS further checks that TID is the right one. Upon success, the point of sales terminal POS completes its part of the offline digital payment by storing the data from signed offline digital payment response 464, including the signature S2 and a timestamp. In this way, the point of sales terminal POS creates a transaction record for the offline digital payment and stores it in a transaction log. Other offline digital payments received by the point of sales terminal POS may also be buffered in the transaction log. The thus buffered transaction record will subsequently be sent to the payment service provider PSP for online settlement, as will be described below for FIG. 4C. Optionally, the smart card SC may also have a transaction log and correspondingly store therein the data of the signed offline digital payment response 464, including the signature S2. This can be seen at 466.

A visual acknowledgement may be given to the user U2 (and merchant M) by the point of sales terminal POS in step 465.

Stage 470 in FIG. 4C illustrates online settling of the offline digital payment at the payment service provider PSP. The point of sales terminal POS builds a transaction block from the transaction records buffered in the transaction log (cf. step 465 in FIG. 4B), and sends the transaction block to the payment service provider PSP in step 472.

The payment service provider PSP processes the received transaction block as follows in step 474. Each transaction (offline digital payment) represented by a transaction record in the transaction block will be checked (using TID and the timestamp) to make sure that the transaction has not already been settled. If the transaction has not been settled already, the payment service provider PSP verifies cert_key_card using the certificate cert_key_psp, and then verifies the signature S using the verified cert_key_card. Upon successful verification, the payment service provider PSP transfers funds, in the Amount of the transaction, from the account associated with the user U2 to the account associated with the payment service provider PSP. In effect, this is the opposite of the transfer of funds made in step 441 of FIG. 4A when the topup of the smartcard SC was made. Hence, the offline digital payment made in FIG. 4B has now been settled.

In case the smart card SC has a transaction log (cf. step 466 in FIG. 4B), the corresponding settlement functionality may be triggered by the smart card SC in step 476 and handled by the payment service provider PSP in step 478.

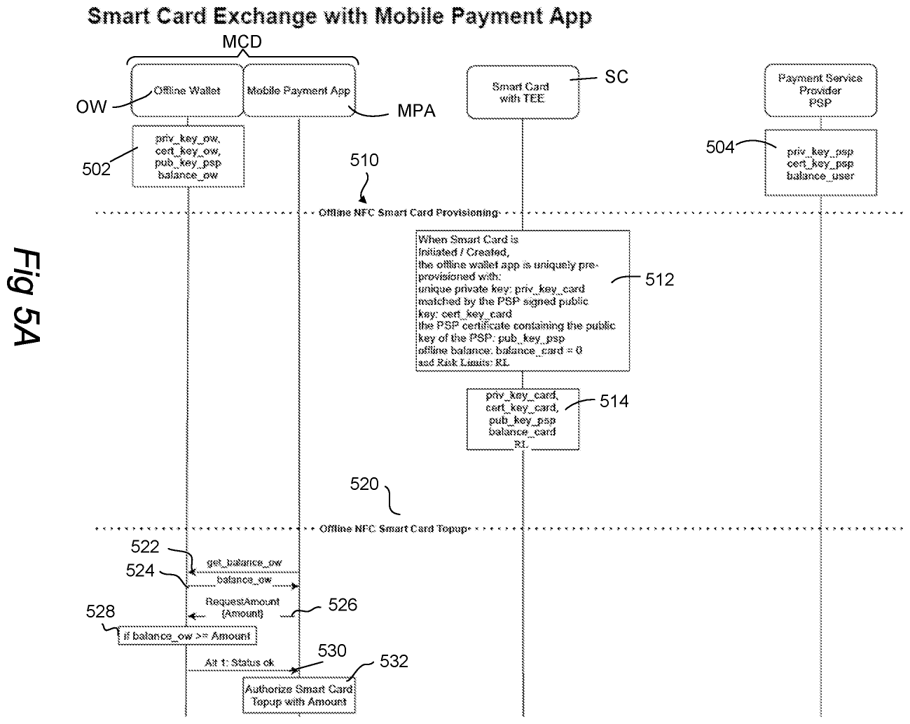

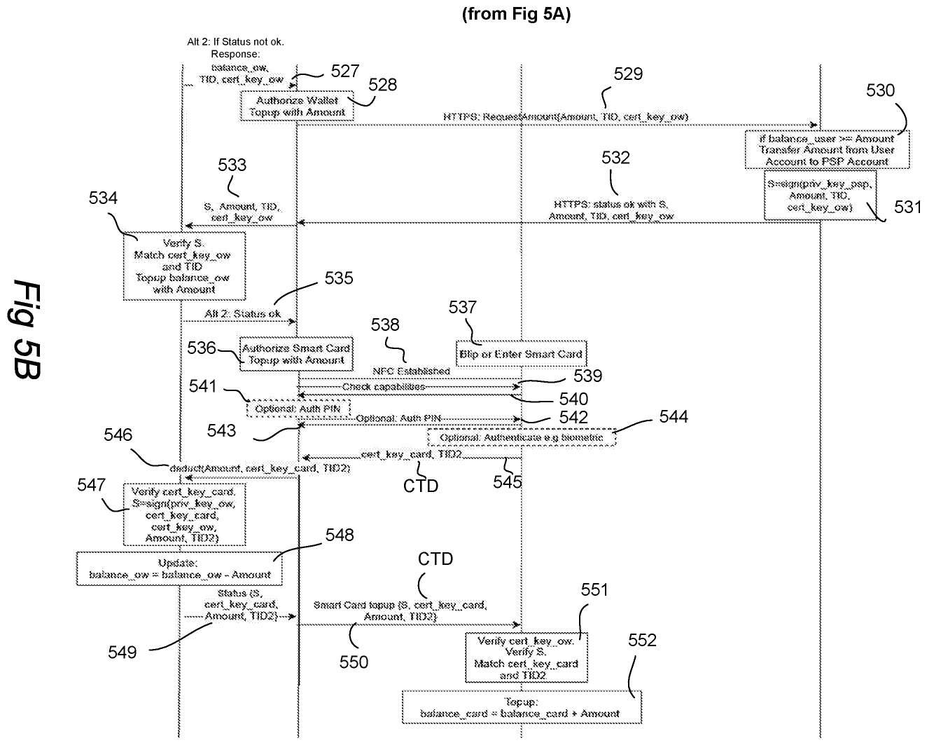

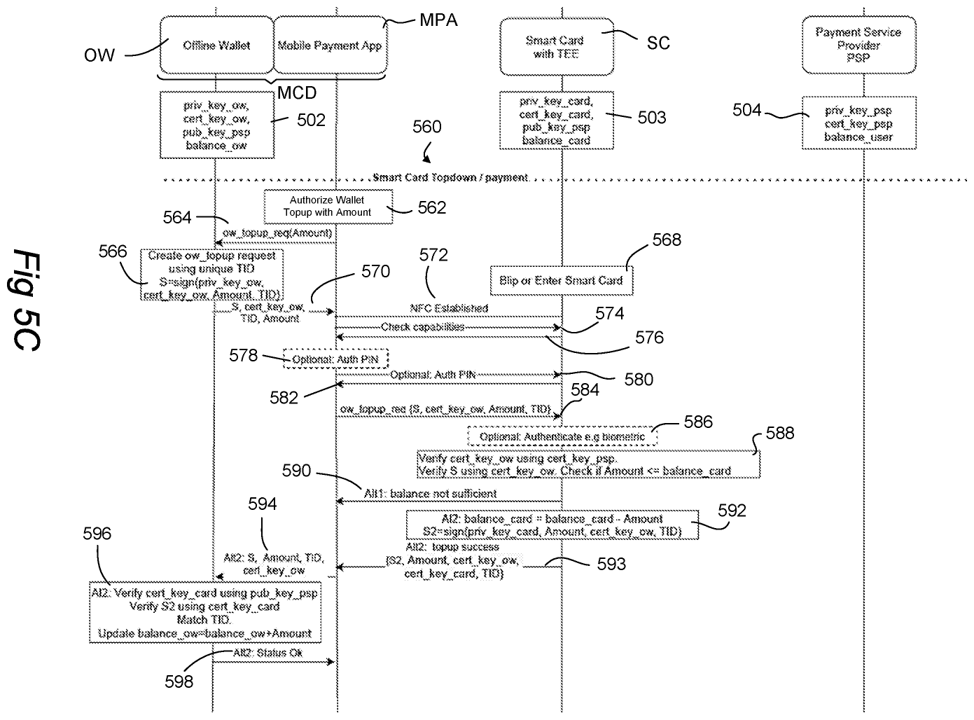

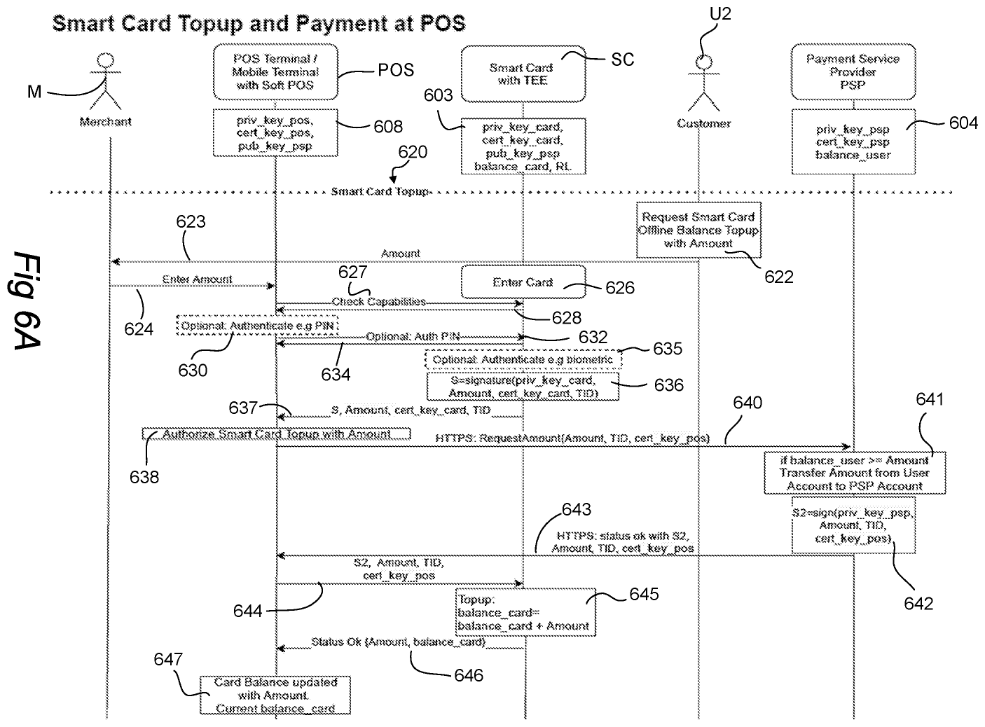

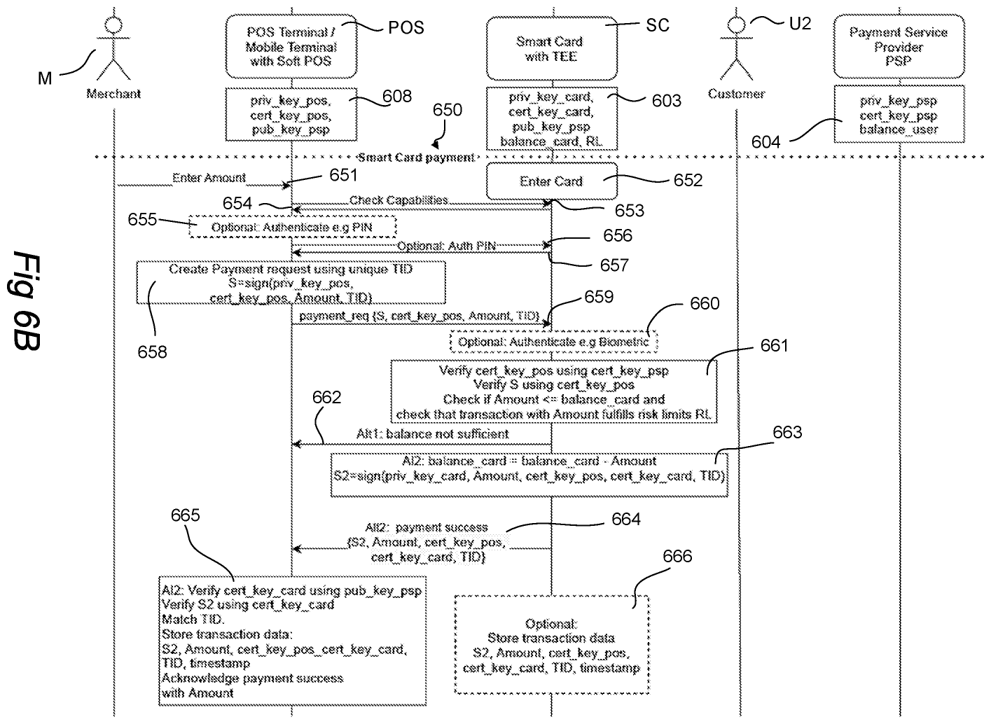

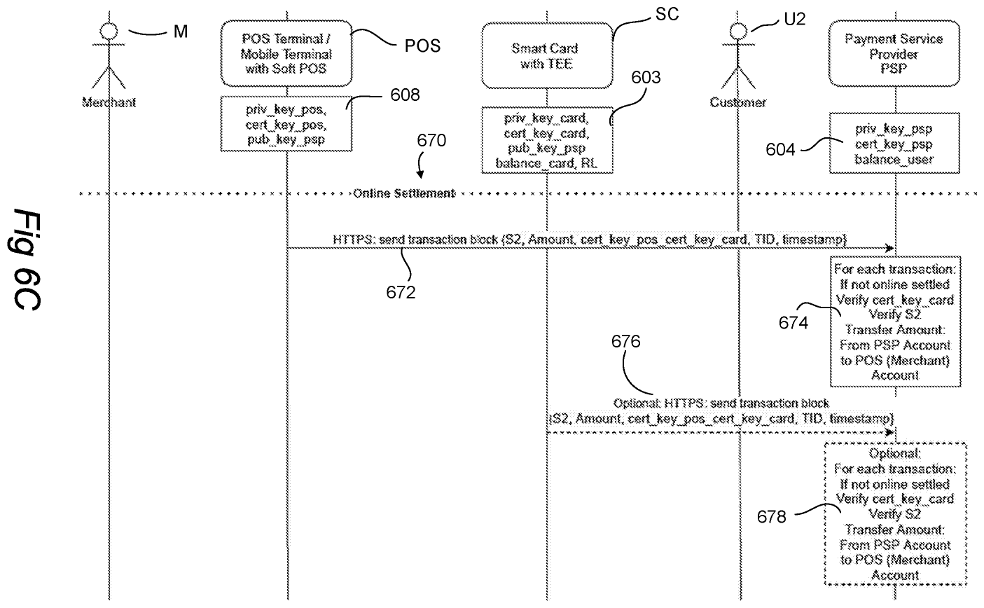

FIGS. 5A-5C and 6A-6C illustrate alternative embodiments which are essentially identical to those shown in 3A-3C and 4A-4C, except that functionality for handling risk limits in the smart card SC has been added. A risk limit profile RL may define one or more of the following:
a total spending limit for digital payments that have not yet been settled;
a maximum payment amount for each digital payment;
a maximum accumulated payment amount for digital payments performable until communicating the contents of a transaction log (cf. stage 670 in FIG. 6C) to the payment service provider PSP;
a maximum accumulated payment amount for digital payments performable during a certain time (such as a day, week, month, etc.);
a maximum number of digital payments performable until communicating the contents of the contents of the transaction log to the payment service provider PSP;
a maximum number of digital payments performable during a certain time (such as a day, week, month, etc.);
a definition of payment receivers that the user U2 is allowed to make digital payments to; and
a definition of payment receivers that the user U2 is not allowed to make digital payments to.

### Software Aspects of the Invention

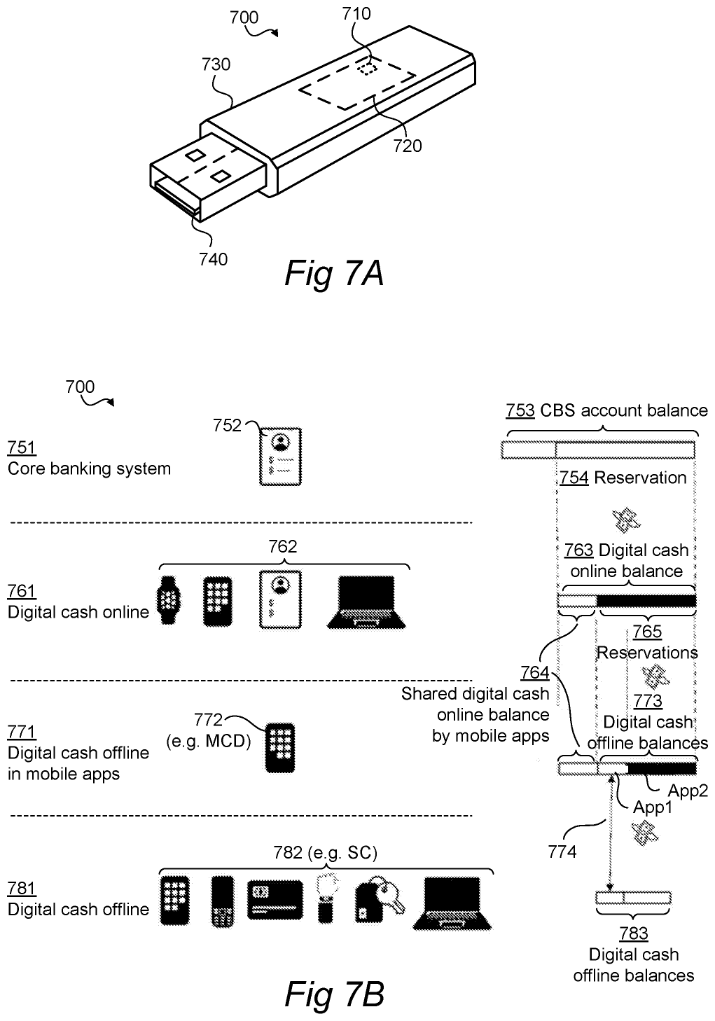

FIG. 7A is a schematic illustration of a (non-transitory) computer-readable medium 700 in one exemplary embodiment, capable of storing a computer program product 710. The computer-readable medium 700 in the disclosed embodiment is a portable memory device, such as a Universal Serial Bus (USB) stick. The computer-readable medium 700 may however be embodied in various other ways instead, as is well-known per se to the skilled person. The portable memory device 700 comprises a housing 730 having an interface, such as a connector 740, and a memory chip 720. In the disclosed embodiment, the memory chip 720 is a flash memory, i.e. a non-volatile data storage that can be electrically erased and re-programmed. The memory chip 720 stores the computer program product 710 which is programmed with computer program code (instructions) that when loaded into a processing device, such as a CPU, will perform any of the functionalities listed in the next paragraph. The processing device may, for instance, be the aforementioned processing device Ctrl. The computer-readable medium 700 is arranged to be connected to and read by a reading device for loading the instructions into the processing device. It should be noted that a computer-readable medium can also be other media such as compact discs, digital video discs, hard drives or other memory technologies commonly used. The computer program code (instructions) can also be downloaded from the computer-readable medium via a wireless interface to be loaded into the processing device.

In one embodiment, therefore, the computer program product 710 comprises computer code for performing the functionality of the mobile communication device MCD in the system 1 or corresponding method as described herein when the computer program code is executed by the processing device. In another embodiment, the computer program product 710 comprises computer code for performing the functionality of the smartcard SC in the system 1 or method as described herein when the computer program code is executed by the processing device. In still other embodiments, the computer program product 710 comprises computer code for performing the functionality of the point of sales terminal POS in the system 1 or method as described herein when the computer program code is executed by the processing device. In yet other embodiments, the computer program product 710 comprises computer code for performing the functionality of the payment service provider PSP in the system 1 or method as described herein when the computer program code is executed by the processing device.

### Multi-Layered Digital Payment System Architecture

FIG. 7B illustrates a multi-layered digital payment system architecture 700, or layout, suitable as an add-on to an existing core banking or payment service provider system layer 751. The multi-layered digital payment system architecture 700 comprises three additional layers which are seen at 761, 771 and 781 in FIG. 7B. Embodiments of the present invention may be implemented at the third layer 781.

The core banking system layer 751 pertains to a financial institution and includes various computerized core banking resources, collectively indicated at 752 in FIG. 7B. The computerized core banking resources 752 maintains an account balance 753 for each account owned or controlled by a bank client. A certain part of the account balance 753 can be reserved 754 for use as a digital cash online balance 763.

The first additional layer 761 is a digital cash online layer which allows users of computerized devices 762 to make digital payments by using the digital cash online balance 763 which has been reserved from the account balance 753 in the core banking system layer 751. As can be seen at 764, the available digital cash online balance 563 may be shared between different payment service applications run by the user's computerized device.

As seen at 765, some (or all) of the available digital cash online balance 763 may be reserved for use as one or more digital cash offline balances 773, potentially one for each payment service application. See App1 and App 2 in FIG. 7B. Such digital cash offline balances 773 pertain to the second additional layer 771 which, thus, is a digital cash offline layer for mobile applications (application programs for mobile communication devices). The digital cash offline layer 771 allows users of mobile communication devices 772 (such as smart phones or tablet computers, including the aforementioned mobile communication device MCD) to make digital payments by using a digital cash offline balance 773 which has been reserved from the digital cash online balance 763 in the digital cash online layer 761.

As can be seen at 774, an available digital cash offline balance 773 may be transferred partly (or fully) between the user's mobile communication device MCD and a smart card 782 (e.g. the aforementioned SC) by way of local point-to-point communication, as previously described. The smart card SC be a separate physical (stand-alone) device, or coupled to, included in or integrated with a mobile communication device or other computerized device, as can be seen for the example devices 782 shown for layer 781 in FIG. 7B. The smart card SC will thus have a digital cash offline balance 783 (i.e., balance_card) which can be used for digital payments. The digital cash offline balance 783 pertains to the third additional layer 781 which, thus, is an extra digital cash offline layer, particularly suited for use with devices which are not enabled for mobile applications. In this way, even those kind of devices are enabled to make offline digital payments.

### Final Remarks

Depending on use case, the users U1 and U2 as referred to in this document may be different persons or one and the same person.

The mobile communication device MCD may, for instance, be a mobile terminal, mobile phone, smart phone, tablet computer, personal digital assistant, smart glasses, smart watch or smart bracelet.

The point of sales terminal POS as referred to in this document may, for instance, be a card reader terminal, a payment terminal, a service terminal, a checkout counter, a delivery pickup point, a vending machine, a ticket machine, a dispensing machine or an access control system. It may also be constituted by a mobile communication device operating as a receiver of a digital payment.

The local point-to-point communication link CL and the local point-to-point communication as referred to in this document may, for instance be in accordance or compliance with the requirements of an NFC Forum Tag or of another NFC Forum Device, or in accordance or compliance with ISO/IEC 14443 Type A standard, ISO/IEC 14443 Type B standard, ISO/IEC 15693 standard, ISO/IEC 18092 standard or JIS-X 6319-4 standard, without limitation.

As used in this document, the term “short-range data communication” includes any form of proximity-based device-to-device communication, unidirectional or bidirectional. This includes radio-based short-range wireless data communication such as, for instance, Bluetooth, BLE (Bluetooth Low Energy), RFID, WLAN, WiFi, mesh communication or LTE Direct, without limitation. It also includes non-radio-based short-range wireless data communication such as, for instance, magnetic communication (such as NFC), audio communication, ultrasound communication, or optical communication (such as QR, barcode, IrDA).

As used in this document, the term “wide area network communication” (abbreviated as “WAN communication”) includes any form of data network communication with a party which may be remote (e.g. cloud-based), including cellular radio communication like W-CDMA, GSM, UTRAN, HSPA, LTE, LTE Advanced or 5G, possibly communicated as TCP/IP traffic, or via a WLAN (WiFi) access point, without limitation. Moreover, the terms “long-range data communication” and “broadband data communication” are considered as synonyms of “wide-area network communication”.

Expressions like “[entity] is configured for . . . [performing activity]” or “[entity] is configured to . . . [perform activity]” will include typical cases where a computerized entity (having one or more controllers, processing units, programmable circuitry, etc.) executes software or firmware installed in the computerized entity, wherein the execution occurs in order to perform the activity in question.

Other aspects, objectives, features and advantages of the inventive aspects will appear from the following detailed disclosure as well as from the claims and the drawings. Generally, all terms used herein are to be interpreted according to their ordinary meaning in the technical field, unless explicitly defined otherwise herein.

All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

Finally, let it be known that in addition to the systems, devices and methods which have been described herein as different inventive aspects, further inventive aspects are corresponding computer program products and computer readable media comprising computer program code for performing the functionalities of these systems, devices and methods. This applies to all disclosed inventive aspects and embodiments of the present disclosure.

1. A digital cash transfer system comprising:
a mobile communication device having a local digital wallet and configured for enabling a user of the mobile communication device to make digital payments from the local digital wallet by wide area network data communication and/or short-range wireless data communication; and
a smart card having an interface for local point-to-point communication, and secure electronic circuitry accommodating a cash deposit and configured for enabling a user of the smart card to make digital payments from the cash deposit at point of sales terminals,
wherein the mobile communication device and the smart card are configured to:
establish a local point-to-point communication link directly between the mobile communication device and the smart card upon being in proximity of each other;
communicate cash transfer data over the local point-to-point communication link, the cash transfer data defining a local transfer of a monetary amount from one of the mobile communication device and the smart card, being a cash sender, to the other of the mobile communication device and the smart card, being a cash receiver; and
update a balance of the local digital wallet as well as a balance of the cash deposit to reflect the local transfer of the monetary amount, such that the balance of the cash sender is reduced while the balance of the cash receiver is increased.

2. The digital cash transfer system according to claim 1, further comprising:
a computerized payment service provider; and
a point of sales terminal,
wherein the payment service provider is configured to communicate with the mobile communication device by wide area network data communication to increase the balance of the local digital wallet in the mobile communication device by transferring funds from an account associated with the user of the mobile communication device to an account associated with the payment service provider,
herein the point of sales terminal is configured for local point-to-point communication with the smart card to receive a digital payment made at the point of sales terminal by the user of the smart card from the cash deposit therein, and is configured to transmit said digital payment to the payment service provider by wide area network data communication, and
wherein the payment service provider is further configured to receive said digital payment made at the point of sales terminal by the user of the smart card, and to cause settlement by causing transfer of funds from an account associated with the payment service provider to an account associated with the point of sales terminal.

3. The digital cash transfer system according to claim 2, wherein the payment service provider is further configured for wide area network data communication with the point of sales terminal, and the point of sales terminal is further configured for local point-to-point communication with the smart card, to increase the balance of the cash deposit in the smart card by transferring funds from an account associated with the user of the smart card to an account associated with the payment service provider.

4. The digital cash transfer system according to claim 1, wherein, when the mobile communication device is the cash sender and the smart card is the cash receiver, the balance of the local digital wallet is reduced by the transferred monetary amount whereas the balance of the cash deposit is increased by the transferred monetary amount, thereby enabling the user of the smart card to make digital payments in a higher total amount than prior to receiving the transferred monetary amount.

5. The digital cash transfer system according to claim 2, wherein the mobile communication device is configured, when being the cash sender, to:
determine that the balance of the local digital wallet is less than the monetary amount to be transferred to the smart card, and
communicate with the payment service provider by wide area network data communication to increase the balance of the local digital wallet in the mobile communication device by transferring funds from an account associated with the user of the mobile communication device to an account associated with the payment service provider.

6. The digital cash transfer system according to claim 1, wherein, when the smart card is the cash sender and the mobile communication device is the cash receiver, the balance of the local digital wallet is increased by the transferred monetary amount whereas the balance of the cash deposit is reduced by the transferred monetary amount, the transferred monetary amount thereby serving as a local digital payment being made by the user of the smart card, acting as a payer, directly to the user of the mobile communication device, acting as a payee.

7. The digital cash transfer system according to claim 6, wherein the balance of the local digital wallet as increased by the transferred monetary amount is available for the user of the mobile communication device, acting as a payer, to make a subsequent digital payment to a user of another mobile communication device, acting as a payee, the subsequent digital payment being in an amount that corresponds to the full or partial increased balance of the local digital wallet in the mobile communication device.

8. The digital cash transfer system according to claim 2, wherein:
the mobile communication device has a certificate which comprises a public cryptographic key, signed by the payment service provider, the mobile communication device further having a private cryptographic key, associated with its public cryptographic key and stored in local memory,
the smart card has a certificate which comprises a public cryptographic key, signed by the payment service provider, the smart card further having a private cryptographic key, associated with its public cryptographic key and stored in local memory,
the payment service provider has a certificate which allows verification of the certificates of the mobile communication device and the smart card, and which is made available to the mobile communication device and the smart card,
he mobile communication device and the smart card are configured, in connection with the communication of cash transfer data over the local point-to-point communication link, to exchange their certificates, thereby allowing mutual verification thereof using the certificate of the payment service provider, and
the cash sender is configured to sign the cash transfer data or parts thereof using its private cryptographic key, whereas the cash receiver is configured to verify the signed cash transfer data or signed parts thereof using the certificate of the cash sender as verified by the certificate of the payment service provider, successful verification being a requisite for updating the balance of the cash receiver.

9. The digital cash transfer system according to claim 1, wherein the smart card comprises a credit card-sized substrate carrying the secure electronic circuitry.

10. The digital cash transfer system according to claims 1, wherein the smart card is a smart chip that contains the secure electronic circuitry.

11. The digital cash transfer system according to claim 10, wherein the smart chip is dimensioned as a subscriber identity module to fit in a subscriber identity module reader in a second mobile communication device carried by the user of the smart card.

12. The digital cash transfer system according to claim 1, wherein the smart card is compatible with EMV, Europay, Mastercard and VISA, payments.

13. The digital cash transfer system according to claim 1, wherein the local point-to-point communication link involves Near Field Communication, NFC.

14. The digital cash transfer system according to claim 1, the secure electronic circuitry in the smart card accommodating biometric reference data pertaining to one or more biometric features of the user of the smart card, wherein the smart card is configured to:
read a biometric sample from the user of the smart card; and
perform a biometric authentication of the biometric sample, the biometric authentication being concluded as successful when the biometric sample matches the biometric reference data,
wherein successful biometric authentication of the user of the smart card is a requisite for the smart card to participate in the local transfer of the monetary amount.

15. A mobile communication device having:
at least one of an interface for wide area network data communication and an interface for short-range wireless data communication;
an interface for local point-to-point communication; and
a local digital wallet,
wherein the mobile communication device is configured for enabling a user of the mobile communication device to make digital payments from the local digital wallet by at least one of wide area network data communication and short-range wireless data communication; and
wherein the mobile communication device is further configured for:
participating in establishing of a local point-to-point communication link directly between the mobile communication device and a smart card when the mobile communication device and the smart card are in proximity of each other;
participating in communication of cash transfer data over the local point-to-point communication link, the cash transfer data defining a local transfer of a monetary amount from one of the mobile communication device and the smart card, being a cash sender, to the other of the mobile communication device and the smart card, being a cash receiver; and
updating a balance of the local digital wallet to reflect the local transfer of the monetary amount, such that the balance of the local digital wallet is reduced in case the mobile communication device is the cash sender and is increased in case the mobile communication device is the cash receiver.

16. (canceled)

17. A smart card having:
secure electronic circuitry accommodating a cash deposit; and
an interface for local point-to-point communication,
wherein the smart card is configured for enabling a user of the smart card to make digital payments from the cash deposit at point of sales terminals,
wherein the smart card is further configured for:
participating in establishing of a local point-to-point communication link directly between the smart card and a mobile communication device when the smart card and the mobile communication device are in proximity of each other;
participating in communication of cash transfer data over the local point-to-point communication link, the cash transfer data defining a local transfer of a monetary amount from one of the smart card and the mobile communication device, being a cash sender, to the other of the smart card and the mobile communication device, being a cash receiver; and
updating a balance of the cash deposit to reflect the local transfer of the monetary amount, such that the balance of the cash deposit is reduced in case the smart card is the cash sender and is increased in case the smart card is the cash receiver.

18. (canceled)

19. A method of transferring digital cash, comprising:
establishing a local point-to-point communication link directly between a mobile communication device and a smart card upon being in proximity of each other;
communicating cash transfer data over the local point-to-point communication link, the cash transfer data defining a local transfer of a monetary amount from one of the mobile communication device and the smart card, being a cash sender, to the other of the mobile communication device and the smart card, being a cash receiver; and
updating a balance of a local digital wallet of the mobile communication device as well as a balance of the cash deposit to reflect the local transfer of the monetary amount, such that the balance of the cash sender is reduced while the balance of the cash receiver is increased.

20. The method as defined in claim 19, further comprising:
a computerized payment service provider communicating with the mobile communication device by wide area network data communication to increase the balance of the local digital wallet in the mobile communication device by transferring funds from an account associated with a user of the mobile communication device to an account associated with the payment service provider;
a point of sales terminal performing local point-to-point communication with the smart card to receive a digital payment made at the point of sales terminal by a user of the smart card from the cash deposit therein;
the point of sales terminal transmitting the digital payment to the payment service provider by wide area network data communication;
the payment service provider receiving the digital payment made at the point of sales terminal by the user of the smart card; and
the payment service provider causing settlement by causing transfer of funds from an account associated with the payment service provider to an account associated with the point of sales terminal.
